(19) United States
(12) Patent Application Publication
(10) Pub. No.: US 2024/0379947 A1
(43) Pub. Date: Nov. 14, 2024

(54) SECONDARY BATTERY AND METHOD FOR MANUFACTURING THE SAME

(71) Applicant: SEMICONDUCTOR ENERGY LABORATORY CO., LTD., Atsugi-shi, Kanagawa-ken (JP)

(72) Inventors: Jun ISHIKAWA, Isehara, Kanagawa (JP); Mayumi MIKAMI, Atsugi, Kanagawa (JP); Miku FUJITA, Akita, Akita (JP); Yohei MOMMA, Isehara, Kanagawa (JP)

(21) Appl. No.: 18/690,309

(22) PCT Filed: Sep. 5, 2022
(86) PCT No.: PCT/IB2022/058313

§ 371 Date: Mar. 8, 2024

(30) Foreign Application Priority Data
Sep. 17, 2021 (JP) 2021-152018

(51) Int. Cl. H01M 4/36; H01M 4/02; H01M 4/04; H01M 4/48; H01M 4/62

(52) U.S. Cl. CPC H01M 4/366; H01M 4/0426; H01M 4/0471; H01M 4/483; H01M 4/622; H01M 4/625; H01M 2004/021; H01M 2004/027

(57) ABSTRACT

An object of an embodiment of the present invention is to provide a negative electrode with high capacity. Another embodiment of the present invention is to provide a novel secondary battery. A surface treatment layer, specifically a metal film typified by a titanium film, is formed on the surface of a SiOx particle. Providing the surface treatment layer can suppress rapid volume expansion of SiOx, thereby reducing a change in volume of the negative electrode active material layer or reducing formation of a space between the negative electrode active materials. Furthermore, providing such a metal film on the particle surface can improve the conductivity. Moreover, a change in quality due to a reaction between the SiOx particle and the electrolyte solution can be reduced owing to the presence of the surface treatment layer.

### TECHNICAL FIELD

The present invention relates to an electrode and a method for manufacturing the electrode. In addition, the present invention relates to an active material included in an electrode and a method for manufacturing the active material. Furthermore, the present invention relates to a secondary battery and a method for manufacturing the secondary battery. Moreover, the present invention relates to a moving vehicle such as a vehicle, a portable information terminal, an electronic device, and the like each including a secondary battery.

One embodiment of the present invention relates to an object, a method, or a manufacturing method. Furthermore, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that an electronic device in this specification means all devices including power storage devices, and electro-optical devices including power storage devices, information terminal devices including power storage devices, and the like are all electronic devices.

Note that in this specification, a power storage device refers to all elements and devices each having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential for today's information society as rechargeable energy supply sources.

Capacity of secondary batteries used in moving vehicles such as electric vehicles or hybrid vehicles need to be increased for longer driving ranges.

Furthermore, portable terminals and the like have more and more functions, resulting in an increase in power consumption. In addition, reductions in size and weight of secondary batteries used for portable terminals and the like are demanded. Therefore, secondary batteries used for portable terminals are also desired to have higher capacity.

It is important for secondary batteries to have high capacity as well as their stability. An alloy-based material such as a silicon-based material has high capacity and thus is promising as an active material of a secondary battery. However, an alloy-based material with high charge and discharge capacity has problems such as pulverization and detachment of an active material due to a volume change in charging and discharging and thus has not achieved sufficient cycle performance.

Patent Document 1 discloses a negative electrode active material covered with a functional material. Note that the functional material is titanium, an oxide containing titanium, an oxynitride containing titanium, or a nitride containing titanium. In Patent Document 1, silicon is used as the negative electrode active material.

### REFERENCES

### Patent Document

### [Patent Document 1]

Japanese Published Patent Application No. 2017-208325

### SUMMARY OF THE INVENTION

### Problems to be Solved by the Invention

One object of one embodiment of the present invention is to provide a negative electrode with mechanical strength. Another object of one embodiment of the present invention is to provide a negative electrode with high capacity. Another object of one embodiment of the present invention is to provide a negative electrode with little deterioration.

Another object of one embodiment of the present invention is to provide a secondary battery with little deterioration. Another object of one embodiment of the present invention is to provide a secondary battery with high safety. Another object of one embodiment of the present invention is to provide a secondary battery with high energy density. Another object of one embodiment of the present invention is to provide a novel secondary battery

Note that the description of these objects does not preclude the existence of other objects. One embodiment of the present invention does not have to achieve all of these objects. Other objects can be derived from the description of the specification, the drawings, and the claims.

### Means for Solving the Problems

There is an attempt to use silicon as a material of a negative electrode of a secondary battery. Silicon has higher capacity than carbon, and has a high theoretical capacity of 4200 mAh/g. However, silicon has problems such as a large proportion of volume expansion and contraction due to alloying or dealloying by a reaction with lithium, a crack of an active material, a change in quality of a surface due to a reaction with an electrolyte solution, and peeling from an electrode of an active material. Thus, as a negative electrode active material, a silicon oxide (or a material in which a silicon oxide and silicon particles are mixed) represented by SiOx (0<X≤2) is used. Specifically, SiOx contains one particle, that is, at least one nanocrystal of silicon in a silicon oxide.

Furthermore, a surface treatment layer, specifically a metal film typified by a titanium film, is formed on a surface of a SiOx particle. Providing the surface treatment layer can suppress rapid volume expansion of SiOx, thereby reducing a change in volume of the negative electrode active material layer or reducing formation of a space between the negative electrode active materials. In addition, providing a titanium film on the particle surface can improve the conductivity. Furthermore, a change in quality due to a reaction between the SiOx particle and an electrolyte solution can be suppressed with the presence of the surface treatment layer. To provide a titanium film in contact with the surface of the SiOx particle, the titanium film is formed on SiOx by a barrel-sputtering method. In addition, a target is used when a metal film is formed by a barrel-sputtering method. Therefore, the composition of a target may contain impurities, and thus impurities may be contained also in the metal film formed in contact with the surface of the SiOx particle.

Furthermore, the SiOx particle provided with a titanium film, a conductive material (carbon black, typically acetylene black), and a binder are mixed to form a slurry, then the slurry is applied to a negative electrode current collector, and heating is performed under a nitrogen atmosphere. Furthermore, a conductive material other than carbon black may be included. The conductive material may be optionally added in the case where the conductivity of the negative electrode active material layer is deficient, and, it may be unnecessary to use the conductive material in the case where the conductivity of the negative electrode active material layer is sufficient owing to the titanium film provided.

The barrel-sputtering method is a film formation method in which a target is fixed to the inside of a container having a polygonal or circular cross section, a sample in particulate forms that is a deposition target is placed therein, and sputtering is performed in vacuum while the container is being rotated. The use of a deposition apparatus employing the barrel-sputtering method enables the formation of a film containing a constituent element of a target on a surface of each particle.

Before the titanium film is formed by a barrel-sputtering method, classification treatment and the subsequent mixing may be repeatedly performed on SiOx a plurality of times.

As a silicon oxide, a composition formula SiOx (0<X≤2) is used. The particle diameter of SiOx to be used is a median diameter of greater than or equal to 0.5 μm and less than or equal to 30 μm.

The silicon oxide may contain a silicon particle. The silicon oxide sometimes contains lithium. The particle of the silicon oxide may be amorphous or crystalline.

With the above structure, a silicon oxide, that is, SiOx is entirely or partially coated with the titanium film, whereby the initial charge-discharge efficiency can be improved.

Preferably, the entire surface of SiOx is thinly coated with the titanium film. The thickness of the titanium film is specifically greater than or equal to 1 nm and less than or equal to 50 nm, preferably greater than or equal to 10 nm and less than or equal to 30 nm.

As a material for the surface treatment layer with which SiOx is entirely or partially coated, one or more of metals belonging to Group 4, Group 5, and Group 6, typically zinc, vanadium, niobium, tantalum, chromium, molybdenum, and tungsten can also be used.

In this specification, SiOx can be expressed as SiO, and is referred to as silicon monoxide, for example in some cases.

Moreover, a method for manufacturing a secondary battery to form a negative electrode active material layer is also one of the structures disclosed in this specification. The structure is a method for manufacturing a secondary battery in which a negative electrode active material is formed by forming a surface treatment layer on a silicon oxide by a barrel-sputtering method, the negative electrode active material and acetylene black are mixed, a precursor of polyimide is mixed after mixing the acetylene black, a mixture is applied to a current collector after mixing the precursor of polyimide, and a negative electrode active material layer is formed on the current collector by performing heat treatment under a nitrogen atmosphere after applying.

In the above structure, the heat treatment is performed in a temperature range of higher than or equal to 100° C. and lower than or equal to 500° C. By the heat treatment, imidation treatment of a precursor of polyimide is performed. The temperature lower than or equal to 500° C. is preferable as a condition where an alloy of a metal contained in the surface treatment layer and silicon is less likely to be produced at the interface between SiOx and the metal film.

### Effect of the Invention

In a secondary battery employing a negative electrode including a current collector on which SiOx coated with the titanium film is provided as the negative electrode active material layer, expansion and shrinkage of SiOx generated in charging and discharging is relieved with the titanium film as the surface treatment layer; thus, the charge-discharge efficiency is improved and the battery characteristics is improved.

Moreover, a high capacity of the negative electrode can be achieved, and a high capacity of the secondary battery can be achieved.

### BRIEF DESCRIPTION OF THE DRAWINGS

FIG. 1 is a diagram showing a SEM image of a negative electrode active material in Example 1.

FIG. 2A is an exploded perspective view of a coin-type secondary battery, FIG. 2B is a perspective view of the coin-type secondary battery, and FIG. 2C is a cross-sectional perspective view thereof.

FIG. 3A illustrates an example of a cylindrical secondary battery. FIG. 3B illustrates an example of the cylindrical secondary battery. FIG. 3C illustrates an example of a plurality of cylindrical secondary batteries. FIG. 3D illustrates an example of a power storage system including the plurality of cylindrical secondary batteries.

FIG. 4A and FIG. 4B are diagrams illustrating examples of a secondary battery, and FIG. 4C is a diagram illustrating a state of the inside of the secondary battery.

FIG. 5A to FIG. 5C are diagrams illustrating an example of a secondary battery.

FIG. 6A and FIG. 6B are diagrams illustrating external views of secondary batteries.

FIG. 7A to FIG. 7C are diagrams illustrating a method for manufacturing a secondary battery.

FIG. 8A to FIG. 8D are diagrams illustrating examples of transport vehicles.

FIG. 9A to FIG. 9D are diagrams illustrating examples of electronic devices.

FIG. 10A and FIG. 10B are graphs showing cell potential characteristics depending on capacity of coin cells of this example.

FIG. 11A and FIG. 11B are graphs showing cell potential characteristics depending on capacity of coin cells of a comparative example.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

A negative electrode active material in this embodiment is a negative electrode material for a lithium-ion secondary battery in which a surface treatment layer is provided for SiOx.

The negative electrode material for a lithium-ion secondary battery in this embodiment will be described in detail below.

As the negative electrode active material, silicon oxide capable of insertion or extraction of lithium ions is used. The theoretical discharge capacity per unit volume is larger than that of a carbon-based negative electrode active material, so that the capacity of a lithium-ion secondary battery can be increased.

As the negative electrode active material, SiOx produced by a deposition method is used. The deposition method is a method in which a mixture of silicon dioxide and silicon is heated under a reduced pressure to generate a silicon monoxide gas, the generated silicon monoxide gas is cooled, and the resultant is deposited and crushed minutely.

The diameter of the SiOx particle to be used is a median diameter of greater than or equal to 0.5 μm and less than or equal to 30 μm. When the particle diameter is less than 0.5 μm, particles are easily aggregated in the manufacturing process of the slurry, which might produce an uneven slurry. There is a concern that the thickness of an electrode to be formed is increased if the particle diameter exceeds 30 μm.

A surface treatment layer is formed on SiOx by a barrel-sputtering method. Titanium is used as a target, sputtering is performed under an argon atmosphere, so that the surface of SiOx is entirely or partially coated with a titanium film. In this embodiment, as the surface treatment layer of SiOx, specifically, a titanium film with a thickness greater than or equal to 1 nm and less than or equal to 50 nm, preferably greater than or equal to 10 nm and less than or equal to 30 nm is provided. The surface treatment layer provided in this manner can impart conductivity to SiOx.

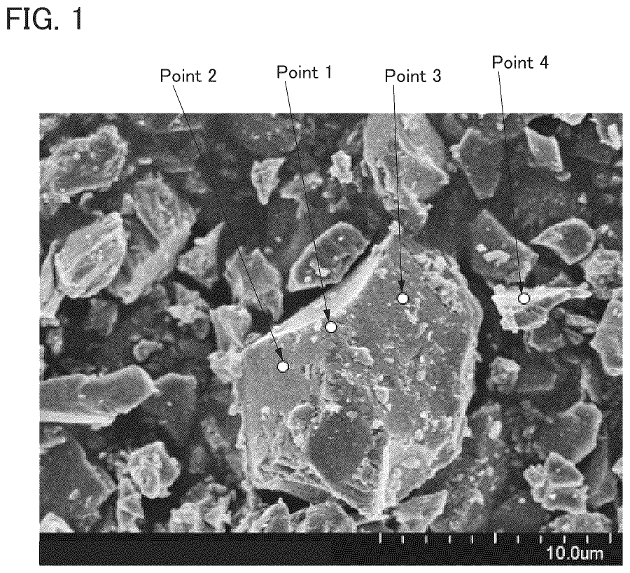

FIG. 1 is a SEM image of SiOx including the surface treatment layer after barrel sputtering.

In addition, a slurry material in which SiOx including the surface treatment layer, a conductive material (also referred to as a conductive additive), and a solvent are mixed together with a binding agent may be used as a negative electrode material for a lithium-ion secondary battery. As the solvent, NMP (N-methylpyrrolidone) or acetone is used. The viscosity of the slurry material can be adjusted as appropriate with the amount of the solvent, a reaction temperature, or reaction time.

As the conductive material, one or more kinds of carbon, copper, tin, zinc, silver, and nickel can be used. In this embodiment, carbon black, specifically acetylene black, is used as the conductive material.

As the binding agent, a resin of polyimide, polyvinylidene fluoride (PVDF), or styrene-butadiene rubber (SBR) is used. Note that in the case where polyimide is used as the binding agent, polyamic acid is polymerized by heating to form a resin, and the polyamic acid is called a precursor of polyimide. The precursor of polyimide refers to a substance that can become polyimide by imidation, and include, without being limited to polyamic acid, partially imidized polyamic acid and polyamic acid ester. It is preferable to use polyamic acid in terms of high solubility in a solvent to be used, low cost, and heat resistance after polyimidation.

A negative electrode including the negative electrode material for a lithium-ion secondary battery can be manufactured in the following manner: the slurry material is applied to a current collector, uniformed to a desired thickness, and dried. The negative electrode for a lithium-ion secondary battery is a negative electrode in which a negative electrode active material layer is provided on a current collector for the negative electrode (also referred to as a negative electrode current collector).

The components of the lithium-ion secondary battery include at least the negative electrode including the negative electrode material for a lithium-ion secondary battery described above, a positive electrode, an electrolyte solution, and a separator.

A separator is provided between the negative electrode and the positive electrode, the resultant body is surrounded by an exterior body, and an electrolyte solution is introduced into the exterior body, whereby a secondary battery is manufactured. The exterior body is a cylindrical casing, a quadrangular casing, and a laminate film casing in pouch form.

In addition, a positive electrode active material layer is provided on a current collector for a positive electrode (also referred to as a positive electrode current collector) in the positive electrode. As the positive electrode active material used for the positive electrode active material layer, a known oxide can be used. Examples of such a known oxide include lithium cobalt oxide (LiCoO₂) and lithium iron phosphate (LiFePO₄).

A material with the layered rock-salt crystal structure, such as lithium cobalt oxide (LiCoO₂), is known to have a high discharge capacity and excel as a positive electrode active material of a lithium-ion secondary battery. Examples of a material with a layered rock-salt crystal structure include a composite oxide represented by LiMO₂. The metal M contains a metal Me1. The metal Me1 is one or more kinds of metals containing cobalt. The metal M can contain a metal X in addition to the metal Me1. The metal X is one or more metals selected from magnesium, calcium, zirconium, lanthanum, barium, copper, potassium, sodium, and zinc.

As an electrolyte solution, for example, one kind of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds of these can be used in an appropriate combination at an appropriate ratio. As a fluorinated cyclic carbonate, a fluorinated ethylene carbonate, e.g., monofluoroethylene carbonate (fluoroethylene carbonate, FEC, or FIEC), difluoroethylene carbonate (DFEC or F2EC), trifluoroethylene carbonate (F3EC), or tetrafluoroethylene carbonate (F4EC) or the like can be used.

As the electrolyte solution, an organic solvent or an ionic liquid can be used. Alternatively, a mixture of an ionic liquid and an organic solvent may be used as the electrolyte solution. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the separator, for example, fiber containing cellulose such as paper; nonwoven fabric; glass fiber; ceramics; synthetic fiber using a nylon resin (polyamide), a vinylon resin (polyvinyl alcohol-based fiber), a polyester resin, an acrylic resin, a polyolefin resin, or a polyurethane resin; or the like can be used. The separator is preferably processed into a pouch-like shape to enclose one of the positive electrode and the negative electrode.

The structure of the lithium-ion secondary battery is not particularly limited to the above structure, and may be a stacked-type secondary battery in which a single layer of each of a positive electrode, a negative electrode, and a separator are stacked or the stacked body is multilayered or a cylindrical secondary battery in which a positive electrode, a negative electrode, and a separator are rolled.

### Embodiment 2

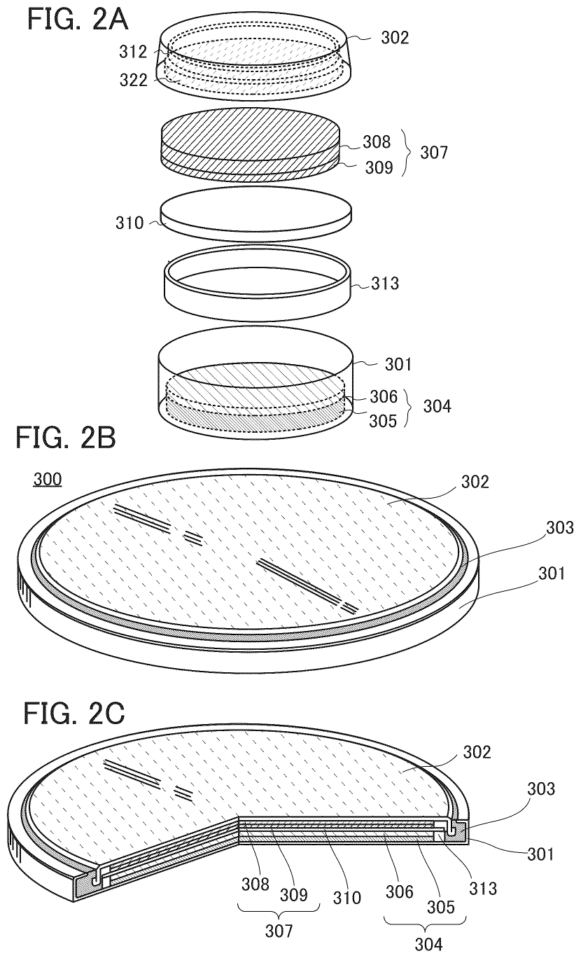

An example of a coin-type secondary battery is described. FIG. 2A is an exploded perspective view of a coin-type (single-layer flat type) secondary battery, FIG. 2B is an external view thereof, and FIG. 2C is a cross-sectional view thereof. Coin-type secondary batteries are mainly used in small electronic devices. In this specification, coin-type batteries include button-type batteries.

FIG. 2A is a schematic view showing overlap (a vertical relation and a positional relation) between components for easy understanding. Thus, FIG. 2A and FIG. 2B do not completely correspond with each other.

In FIG. 2A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 2A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 2B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 can be provided with an active material layer.

For the positive electrode can 301 and the negative electrode can 302, a metal having corrosion resistance to a liquid electrolyte, such as nickel, aluminum, or titanium, an alloy of such a metal, or an alloy of such a metal and another metal (e.g., stainless steel) can be used. Coating with nickel and aluminum is preferable in order to prevent corrosion due to the liquid electrolyte. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the liquid electrolyte; as illustrated in FIG. 2C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

By using the negative electrode active material layer described in Embodiment 1 for the negative electrode 307 of the secondary battery, the coin-type secondary battery 300 can have high charge-discharge efficiency and excellent battery performance. Note that in the case of a secondary battery, the separator 310 is not necessarily provided between the negative electrode 307 and the positive electrode 304.

### [Cylindrical Secondary Battery]

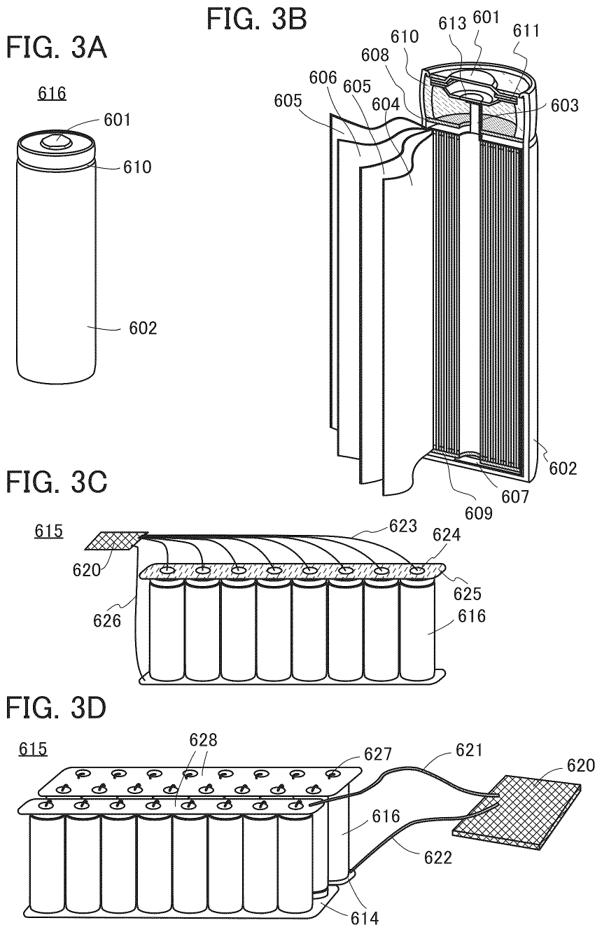

An example of a cylindrical secondary battery is described with reference to FIG. 3A. As illustrated in FIG. 3A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 3B schematically illustrates a cross section of a cylindrical secondary battery. The cylindrical secondary battery illustrated in FIG. 3B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like separator 605 located therebetween is provided. Although not illustrated, the battery element is wound around a central axis. One end of the battery can 602 is close and the other end thereof is open. For the battery can 602, a metal having corrosion resistance to a liquid electrolyte, such as nickel, aluminum, or titanium, an alloy of such a metal, and an alloy of such a metal and another metal (e.g., stainless steel) can be used. The battery can 602 is preferably covered with nickel and aluminum in order to prevent corrosion due to the liquid electrolyte. Inside the battery can 602, the battery element in which the positive electrode, the negative electrode, and the separator are wound is provided between a pair of insulating plates 608 and 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical storage battery are wound, active materials are preferably formed on both surfaces of a current collector. Note that although FIG. 3A to FIG. 3D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

By using the negative electrode active material layer described in Embodiment 1 for the negative electrode 606 of the secondary battery, the secondary battery 616 can have high charge-discharge efficiency and excellent battery performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material of aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics can be used for the PTC element.

FIG. 3C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used.

FIG. 3D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 3D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

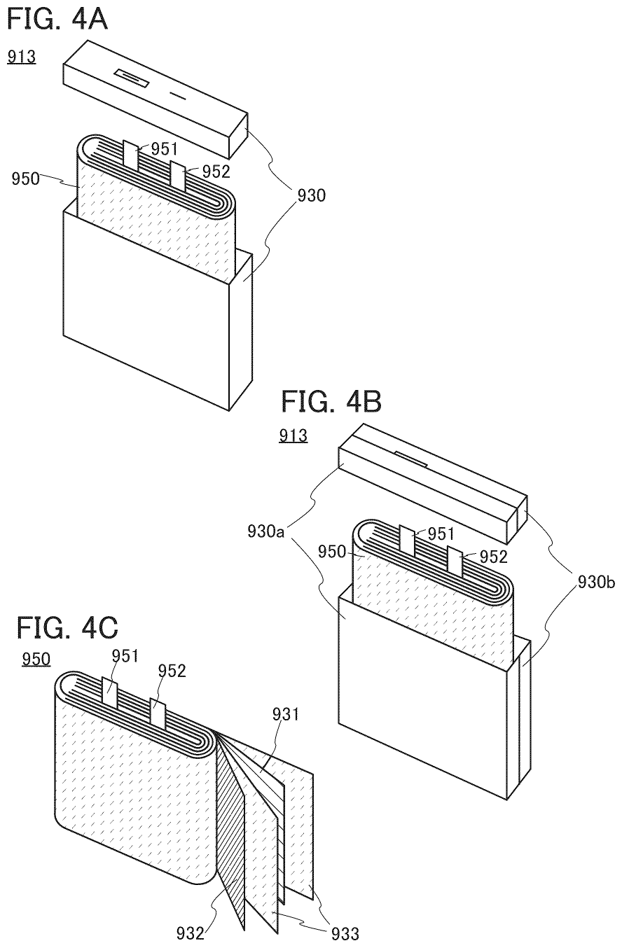

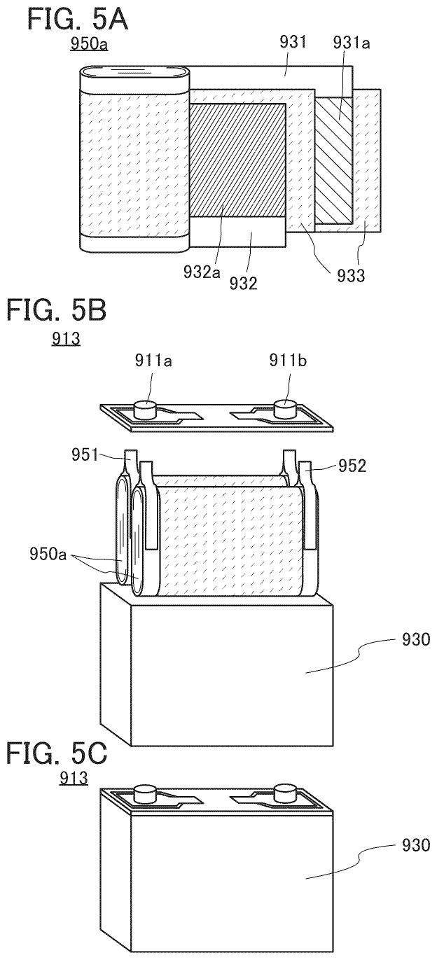

Structure examples of secondary batteries are described with reference to FIG. 4 and FIG. 5.

A secondary battery 913 illustrated in FIG. 4A includes a wound body 950 provided with a terminal 951 and a terminal 952 inside a housing 930. The wound body 950 is immersed in a liquid electrolyte inside the housing 930. The terminal 952 is in contact with the housing 930, and the terminal 951 is not in contact with the housing 930 with use of an insulator. Note that in FIG. 4A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 4B, the housing 930 illustrated in FIG. 4A may be formed using a plurality of materials. For example, in the secondary battery 913 illustrated in FIG. 4B, a housing 930a and a housing 930b are attached to each other, and the wound body 950 is provided in a region surrounded by the housing 930a and the housing 930b.

For the housing 930a, an insulating material of an organic resin can be used. In particular, when an organic resin material is used for the side on which an antenna is formed, blocking of an electric field by the secondary battery 913 can be reduced. When an electric field is less blocked by the housing 930a, an antenna may be provided inside the housing 930a. For the housing 930b, a metal material can be used, for example.

FIG. 4C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 5A to FIG. 5C, the secondary battery 913 may include a wound body 950a. The wound body 950a illustrated in FIG. 5A includes the negative electrode 931, the positive electrode 932, and the separators 933. The negative electrode 931 includes a negative electrode active material layer 931a. The positive electrode 932 includes a positive electrode active material layer 932a.

By using the negative electrode active material layer described in Embodiment 1 for the negative electrode 931 of the secondary battery, the secondary battery 913 can have high charge-discharge efficiency and excellent battery performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 5B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 5C, the wound body 950a and a liquid electrolyte are covered with the housing 930, whereby the secondary battery 913 is completed. The housing 930 is preferably provided with a safety valve and an overcurrent protection element. In order to prevent the battery from exploding, a safety valve is a valve to be released when the internal pressure of the housing 930 reaches a predetermined pressure.

As illustrated in FIG. 5B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 4A to FIG. 4C can be referred to for the other components of the secondary battery 913 illustrated in FIG. 5A and FIG. 5B.

### <Laminated Secondary Battery>

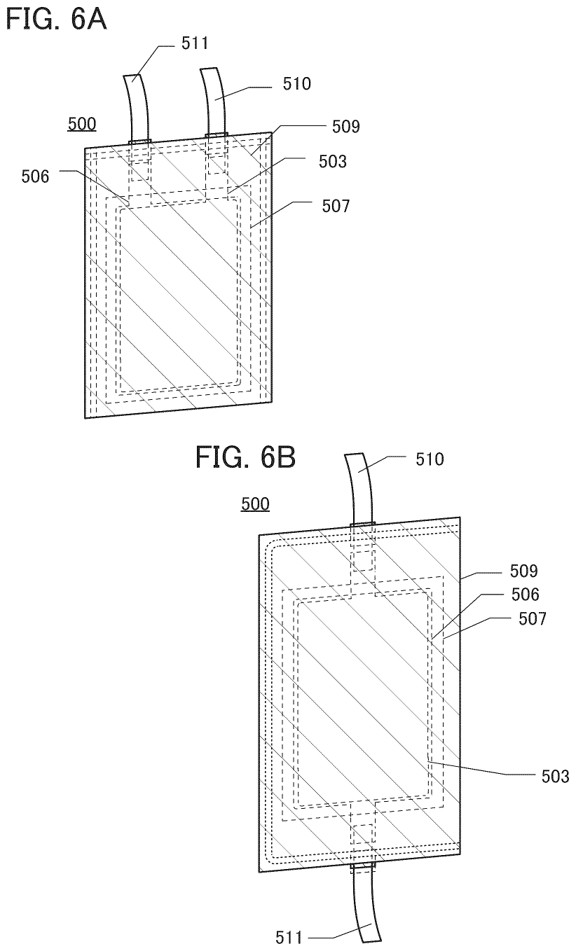

Next, examples of the external view of a laminated secondary battery are illustrated in FIG. 6A and FIG. 6B. In FIG. 6A and FIG. 6B, a positive electrode 503, a negative electrode 506, a separator 507, an exterior body 509, a positive electrode lead electrode 510, and a negative electrode lead electrode 511 are included.

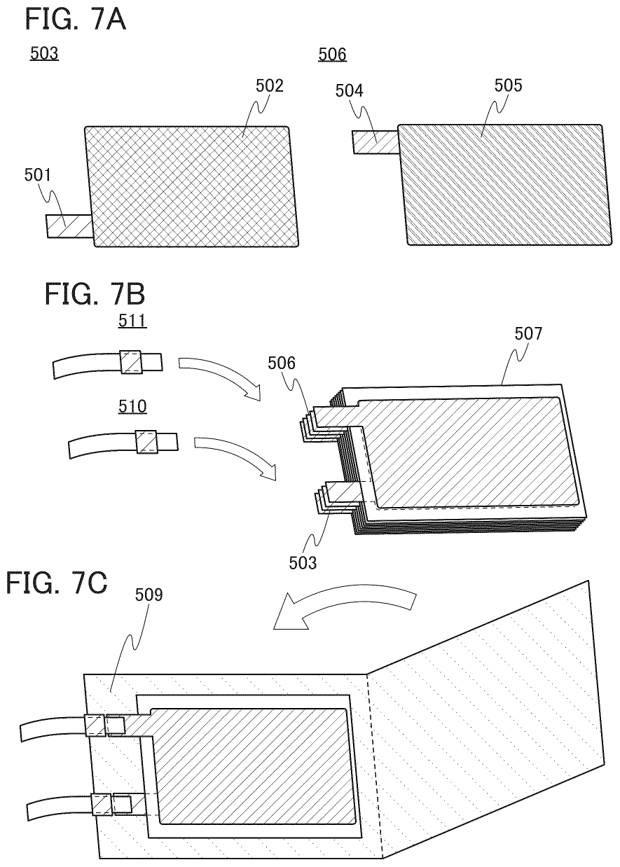

FIG. 7A illustrates the external view of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 7A.

### <Method for Manufacturing Laminated Secondary Battery>

Here, an example of a method for manufacturing the laminated secondary battery whose external view is shown in FIG. 6A is described with reference to FIG. 7B and FIG. 7C.

First, the negative electrode 506, the separator 507, and the positive electrode 503 are stacked. FIG. 7B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 7C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that a liquid electrolyte can be introduced later.

Next, the liquid electrolyte (not illustrated) is introduced into the exterior body 509 from the inlet of the exterior body 509. The liquid electrolyte is preferably introduced in a reduced pressure atmosphere or in an inert atmosphere. Lastly, the inlet is sealed by bonding. In this manner, the laminated secondary battery 500 can be manufactured.

By using the negative electrode active material layer described in Embodiment 1 for the negative electrode 506 of the secondary battery, the secondary battery 500 can have high charge-discharge efficiency and excellent battery performance.

The contents of this embodiment can be freely combined with the contents of the other embodiments.

### Embodiment 3

Examples in which the secondary battery of one embodiment of the present invention is mounted on a vehicle, typically a transport vehicle, will be described.

Mounting the secondary battery described in Embodiment 2 on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

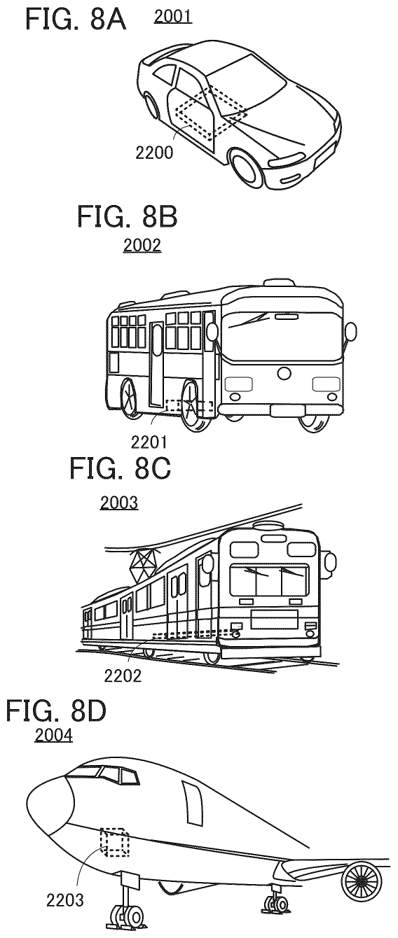

FIG. 8A to FIG. 8D illustrate examples of transport vehicles using one embodiment of the present invention. A motor vehicle 2001 illustrated in FIG. 8A is an electric vehicle that runs using an electric motor as a driving power source. Alternatively, the motor vehicle 2001 is a hybrid vehicle that can appropriately select an electric motor or an engine as a driving power source. In the case where the secondary battery is mounted on the vehicle, an example of the secondary battery described in Embodiment 4 is provided at one position or several positions. The motor vehicle 2001 illustrated in FIG. 8A includes a battery pack 2200, and the battery pack includes a secondary battery module in which a plurality of secondary batteries are connected to each other. Moreover, the battery pack preferably includes a charge control device that is electrically connected to the secondary battery module.

The motor vehicle 2001 can be charged when the secondary battery included in the motor vehicle 2001 is supplied with electric power from external charge equipment by a plug-in system and a contactless charge system. In charging, a given method such as CHAdeMO (registered trademark) or Combined Charging System may be employed as a charge method and the standard of a connector, as appropriate. A secondary battery may be a charging station provided in a commerce facility or a power source in a house. For example, with the use of the plug-in system, the power storage device mounted on the motor vehicle 2001 can be charged by being supplied with electric power from the outside. Charge can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 8B illustrates a large transporter 2002 having a motor controlled by electricity, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 8A except for the number of secondary batteries configuring the secondary battery module; thus, the description is omitted.

FIG. 8C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. By using the negative electrode active material layer described in Embodiment 1 for the negative electrode, the charge-discharge efficiency is improved and the battery performance is improved. A battery pack 2202 has the same function as that in FIG. 8A except for the number of secondary batteries configuring the secondary battery module; thus, the description is omitted.

FIG. 8D illustrates an aircraft 2004 having a combustion engine as an example. The aircraft 2004 illustrated in FIG. 8D can be regarded as a kind of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 8A except for the number of secondary batteries configuring the secondary battery module; thus, the description is omitted.

The contents of this embodiment can be combined with the contents of the other embodiments as appropriate.

### Embodiment 4

In this embodiment, examples of electronic devices each including the secondary battery of one embodiment of the present invention will be described. Examples of the electronic device including the secondary battery include a television device (also referred to as a television or a television receiver), a monitor for a computer, a digital camera, a digital video camera, a digital photo frame, a mobile phone (also referred to as a cellular phone or a mobile phone device), a portable game machine, a portable information terminal, an audio reproducing device, and a large-sized game machine of a pachinko machine. Examples of the portable information terminal include a laptop personal computer, a tablet terminal, an e-book reader, and a mobile phone.

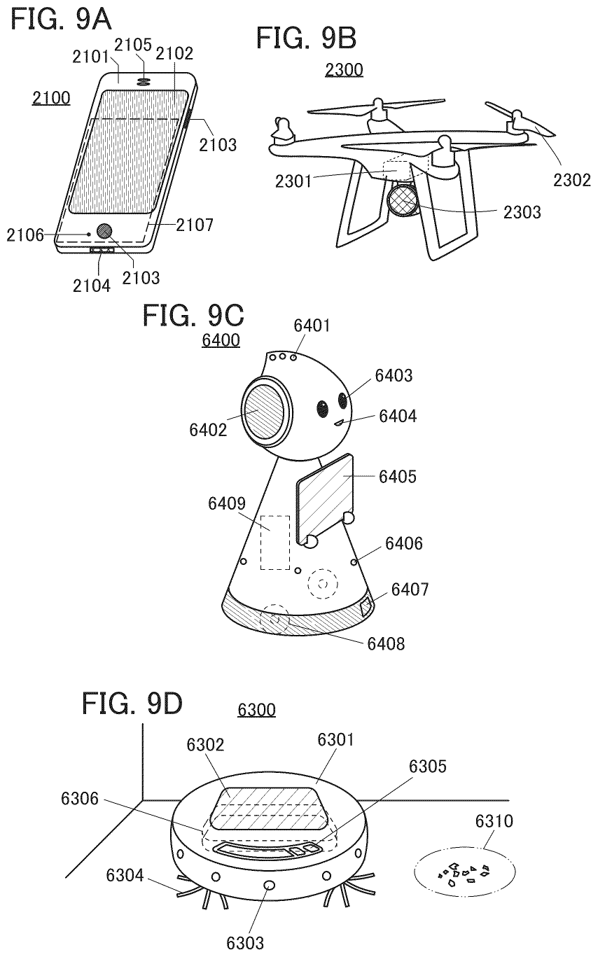

FIG. 9A illustrates an example of a mobile phone. A mobile phone 2100 includes a housing 2101 in which a display portion 2102 is incorporated, operation buttons 2103, an external connection port 2104, a speaker 2105, or a microphone 2106. The mobile phone 2100 includes a secondary battery 2107. The secondary battery 2107 including the negative electrode active material layer described in Embodiment 1 in the negative electrode has improved charge-discharge efficiency and improved battery performance

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a body temperature sensor; a touch sensor; a pressure sensitive sensor; or an acceleration sensor is preferably mounted, for example.

FIG. 9B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery including the negative electrode active material layer described in Embodiment 1 in the negative electrode has improved charge-discharge efficiency and improved battery performance.

FIG. 9C illustrates an example of a robot. A robot 6400 illustrated in FIG. 9C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, and an arithmetic device.

The microphone 6402 has a function of detecting a speaking voice of a user and an environmental sound. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. The secondary battery including the negative electrode active material layer described in Embodiment 1 in the negative electrode has improved charge-discharge efficiency and improved battery performance.

FIG. 9D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, or a variety of sensors. Although not illustrated, the cleaning robot 6300 is provided with a tire or an inlet. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. The secondary battery including the negative electrode active material layer described in Embodiment 1 in the negative electrode has improved charge-discharge efficiency and improved battery performance.

The contents of this embodiment can be combined with the contents of the other embodiments as appropriate.

### Example

A negative electrode for a lithium-ion secondary battery manufactured in this example is described below.

First, SiO powder (granularity less than 45 μm) produced by OSAKA Titanium technologies was used as SiOx. Note that the SiO powder used in this example is a material containing one or more nanocrystals (silicon) in a silicon oxide.

A surface treatment layer was provided on SiOx by a barrel-sputtering method using a titanium target under the following conditions: the deposition power of 400 W, the deposition time of 180 minutes, an argon atmosphere, and the pressure of 1 Pa. The target value of the thickness of the titanium film was 20 nm. Under the sputtering conditions in this example, an alloy of titanium and silicon is less likely to be generated at an interface between SiOx and the titanium film. If an alloy of titanium and silicon is generated, the initial capacity per weight of silicon capable of lithium insertion may be decreased.

FIG. 1 is an SEM image after formation of the surface treatment layer of the titanium film formed by a barrel-sputtering method, and Table 1 shows the atomic concentrations at Point 1, Point 2, Point 3, and Point 4 in FIG. 1.

TABLE 1

Atomic concentration %

| Element | Point 1 | Point 2 | Point 3 | Point 4 |
|---|---|---|---|---|
| C | 15.3 | 14.8 | 23.8 | 21.96 |
| O | 58.75 | 55.63 | 44.67 | 55.57 |
| Si | 25.14 | 29.09 | 30.67 | 21.39 |
| Ti | 0.81 | 0.48 | 0.85 | 1.08 |
| Total | 100 | 100 | 100 | 100 |

As apparent from Table 1, titanium is detected, which confirms that the titanium film was formed on the surface of SiOx

Next, the amount of SiOx having the surface treatment layer on its surface was weighed and an appropriate amount of NMP was added to adjust a slurry viscosity and the mixture was stirred.

Then, acetylene black was weighed as a conductive material, so that the mixture is kneaded with use of a spatula. Then, an appropriate amount of NMP was added to adjust the slurry viscosity and the mixture was stirred.

Next, a solution of a precursor of polyimide was weighed as the binding agent and stirred. Then, an appropriate amount of NMP was added to adjust the slurry viscosity and the mixture was stirred.

As the current collector, one or more kinds of silver, copper, aluminum, tungsten, zinc, nickel, iron, titanium, tantalum, chromium, and molybdenum are used. In addition, stainless steel can be used as the current collector. In this example, a Ni-plated steel foil was used as the current collector for the negative electrode, and the slurry was dropped and applied with a doctor blade (a gap of 50 μm) to the Ni-plated steel foil.

Next, drying was performed at 50° C. for one hour, and then heat treatment was performed at higher than or equal to 100° C. and lower than or equal to 500° C. under a reduced pressure or a nitrogen atmosphere. In this example, the heat treatment was performed under a nitrogen atmosphere at 400° C. for five hours. Through this heat treatment, imidation of the precursor of polyimide was performed. In this manner, a negative electrode active material layer was formed on the current collector for the negative electrode. Also in the heat treatment, an alloy of titanium and silicon was less likely to be generated at the interface between SiOx and the titanium film.

After the heat treatment for imidation, the current collector provided with the negative electrode active material layer was processed into a desired shape.

Through the above steps, the negative electrode of the lithium-ion secondary battery was manufactured. With the use of the negative electrode for a lithium-ion secondary battery, a half cell including lithium as a counter electrode was assembled as a coin cell. Two samples of coin cells were prepared.

As an electrolyte solution, 1 mol/L of lithium hexafluorophosphate (LiPF₆) was used as an electrolyte, and ethylene carbonate (EC) and diethyl carbonate (DEC) were mixed at EC:DEC=3:7 (volume ratio).

As a separator, 25-μm-thick polypropylene was used.

A positive electrode can and a negative electrode can formed of stainless steel (SUS) were used.

In addition, a negative electrode for a lithium-ion secondary battery including SiOx, which was not provided with the surface treatment layer formed by a barrel-sputtering method, was manufactured as a comparative example. As the comparative example, two half cells that were assembled in the same manner were prepared as the coin cells.

### (Evaluation of Initial Charge-Discharge Efficiency)

The coin cells in which the electrode including the negative electrode active material layer was a negative electrode and the counter electrode was lithium were subjected to constant current charge at a current of 0.1 C rate and at 25° C. until the voltage reached 0.01 V (vs. lithium) and then constant voltage charge was performed with the voltage of 0.01 V maintained until the current reached 0.01 C. The capacity at this time was set as an initial charge capacity.

After that, a ten-minute pause was given. After the pause, discharge was performed at a constant current of 0.1 C until the voltage reached 1.5 V (vs. lithium). The capacity at this time was set as an initial discharge capacity.

In addition, an initial charge-discharge efficiency was calculated by dividing the value of the initial charge capacity by the value of the initial discharge capacity. Table 2 shows each numerical value.

TABLE 2

| | Comparative | Comparative | | |
|---|---|---|---|---|
| | example 1 | example 2 | Sample 1 | Sample 2 |
| Condition | SiO | SiO | SiO | SiO |
| | (No | (No | (Ti | (Ti |
| | treatment) | treatment) | coating) | coating) |
| Initial discharge | 1824.19 | 1804.10 | 1839.63 | 1877.72 |
| capacity [mAh/g] | | | | |
| Initial charge- | 63.99 | 64.21 | 72.03 | 72.06 |
| discharge | | | | |
| efficiency [%] | | | | |

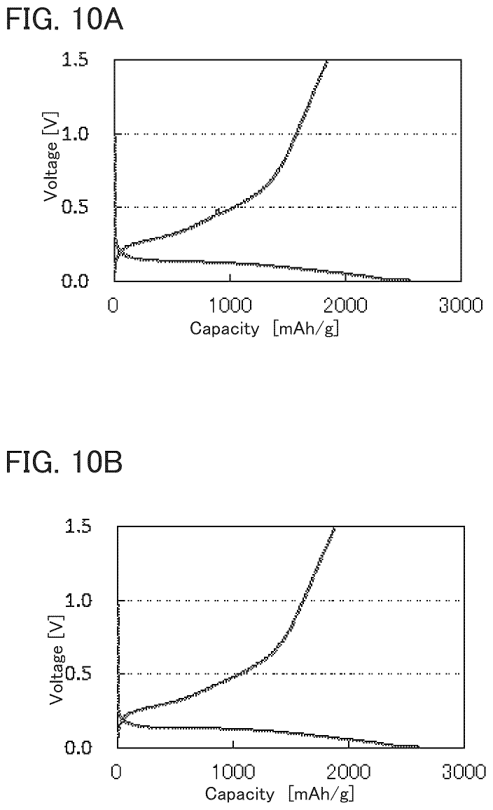

As shown in Table 2, the two samples of this example, Samples 1 and 2, represent 72.03% and 72.06%, respectively. The characteristics of the samples are shown in FIG. 10A and FIG. 10B.

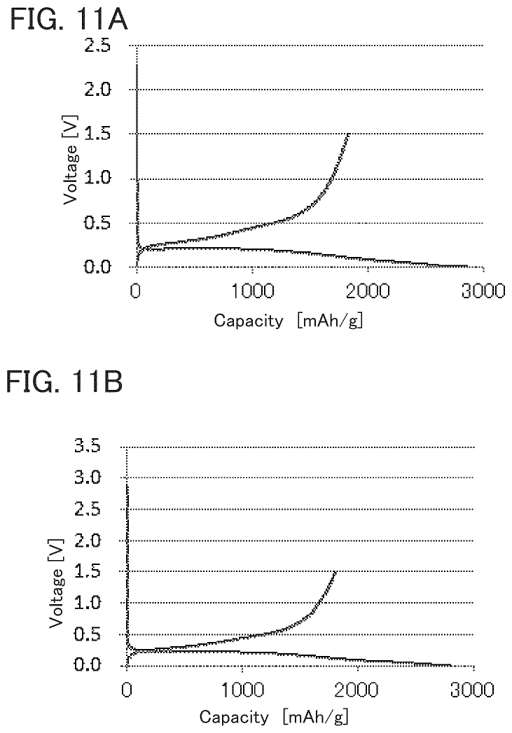

On the other hand, as shown in Table 2, two samples of the comparative example represent 63.99% and 64.21%, respectively. The characteristics of the comparative example are shown in FIG. 11A and FIG. 11B.

As compared with the comparative example, the coin cell in this example is elucidated to show high values of both the initial discharge capacity and the initial charge-discharge efficiency. Accordingly, the experiment results reveal that the negative electrode in this example reduces the initial irreversible capacity and is advantageous in the initial efficiency, as compared with the comparative examples.

In the comparative examples, it is probable that silicon and the electrolyte solution are in direct contact with each other, which decreases the initial discharge capacity.

A discharge rate refers to the relative ratio of current at the time of discharge to battery capacity and is expressed in a unit C. A current corresponding to 1 C in a battery with a rated capacity X (Ah) is X (A). The case where discharge is performed with a current of 2X (A) is rephrased as that discharge is performed at 2 C, and the case where discharge is performed with a current of X/5 (A) is rephrased as that discharge is performed at 0.2 C. The same applies to a charge rate; the case where charge is performed with a current of 2X (A) is rephrased as that charge is performed at 2 C, and the case where charge is performed with a current of X/5 (A) is rephrased as that charge is performed at 0.2 C.

Constant current charge refers to, for example, a method in which charge is performed at a constant charge rate. Constant voltage charge refers to a charge method in which charge is performed at a constant charge voltage which has reached an upper voltage limit, for example. Constant current discharge refers to, for example, a method in which discharge is performed at a constant discharge rate.

Although test results of the half cells were described in this example, the similar effects can be obtained in test results of full cells.

In this specification and the like, a charge voltage and a discharge voltage are voltages in the case of using a lithium counter electrode, unless otherwise specified. Note that even when the same negative electrode is used, the charge and discharge voltages of a secondary battery vary depending on the material used for the positive electrode.

### REFERENCE NUMERALS

300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 313: ring-shaped insulator, 322: spacer

1. A secondary battery comprising:
a positive electrode;
a negative electrode; and
an electrolyte solution,
wherein the positive electrode comprises a first current collector and a positive electrode active material layer over a surface of the first current collector,
wherein the negative electrode comprises a second current collector and a negative electrode active material layer over a surface of the second current collector,
wherein the negative electrode active material layer comprises a silicon oxide (SiOx (0<X≤2)),
wherein a surface treatment layer is provided in contact with a surface of the silicon oxide, and
wherein the surface treatment layer is a metal.

2. The secondary battery according to claim 1, wherein the surface treatment layer has a thickness of greater than or equal to 10 nm and less than or equal to 30 nm.

3. The secondary battery according to claim 1, wherein the surface treatment layer is formed by a barrel-sputtering method.

4. The secondary battery according to claim 1, wherein the metal is titanium.

5. The secondary battery according to claim 1, wherein the electrolyte solution and a separator are provided between the first current collector and the second current collector.

6. A method for manufacturing a secondary battery, comprising the steps of:
forming a negative electrode active material by forming a surface treatment layer of a metal on a silicon oxide by a barrel-sputtering method;
mixing the negative electrode active material and acetylene black;
mixing a precursor of polyimide after the mixing the negative electrode active material and the acetylene black;
applying a slurry to a current collector after the mixing the precursor of polyimide; and
forming a negative electrode active material layer on the current collector by performing heat treatment under a nitrogen atmosphere after applying the slurry to the current collector.

7. The method for manufacturing a secondary battery according to claim 6,
wherein the heat treatment is performed in a temperature range of higher than or equal to 100° C. and lower than or equal to 500° C.

8. The method for manufacturing a secondary battery according to claim 6,
wherein the metal is titanium.
